(19) United States
(12) Patent Application Publication
(10) Pub. No.: US 2013/0125594 A1
(43) Pub. Date: May 23, 2013

(54) Spinning Nozzle Arrangement

(71) Applicant: Rudolf Singer, Engelstadt (DE)

(72) Inventor: Rudolf Singer, Engelstadt (DE)

(21) Appl. No.: 13/504,523

(22) PCT Filed: Oct. 28, 2010
(86) PCT No.: PCT/EP10/06599

§ 371 Date: May 30, 2012

(30) Foreign Application Priority Data
Oct. 28, 2009 (DE) 102009051067.2

(51) Int. Cl. C03B 37/083

(52) U.S. Cl. CPC C03B 37/083
USPC 65/469; 65/495

(57) ABSTRACT

The object of the invention is to provide a spinning nozzle arrangement, which enables an increase, and thus an improvement, in productivity without the said drawbacks and displays as homogeneous a temperature distribution as possible in the region of the nozzle. The object is achieved by a spinning nozzle arrangement (10) for the manufacture of glass fibres, having a melting chamber (11) which is formed by side walls (12,12′), cover plates (14,14′), end plates, a base plate (1), which is provided with a multiplicity of openings or nozzles (2) aligned parallel to the side walls (12) of the spinning nozzle (10), and a feed line (13) for the glass melt (17), characterized in that the base plate (1) is provided on its top side with additional stiffening elements (4), which are connected to the cover plates (14,14′).

In the manufacture of glass fibres, in particular of glass fibres intended for use in glass-fibre reinforced plastics, the starting materials for the glass are fused in a furnace, the formed glass melt is fed to various spinning points, in which the glass mass is discharged through glass fibre nozzles, so-called bushings. The glass threads discharged from the nozzles are drawn off, cooled, for example by air cooling or spraying with water, and bunched together to form one or more fibre bundles. The fibre bundles are provided, if necessary, with a preparation and are then wound onto bobbins or fed to a cutting apparatus. This material is used for further processing, for example in the production of glass-fibre reinforced thermoplastics.

In disclosure document EP 229 648 A1, a typical spinning nozzle for the spinning of glass fibres is represented. The spinning nozzle has rows of tips in a base plate, which are arranged along a straight line from end plate to end plate of the nozzle. On each of the end plates there are two separate power supplies. Via the power supply, an electric current is conducted through the spinning nozzle, which is designed to effect the heating of the glass melt. Although this geometry is designed to offer advantages over the prior art with respect to the uniformity of heating of the glass melt, the practice of use of such bushings shows variances in the temperature distribution and, consequently, in the uniformity of the glass fibre diameter.

In patent specification JP 1 333 011, a manufacturing method for glass fibre spinning nozzles is described. In this method, the tips for the spinning nozzle are attached to the spinning nozzle by prefabricated conical tip elements being soldered, with the aid of a platinum washer, into prepared bores in the spinning nozzle. The tips are here respectively combined into twin rows, which run transversely to the direction of the heating current through the base plate of the spinning nozzle. Numerous problems arise, however, during use.

The spinning output at the spinning points is determined, inter alia, by the total number or number per unit of area of the nozzle tips, hereinafter referred to in short as tips, on the spinning nozzle. The number of tips on a spinning nozzle arrangement, however, is limited. This is due, on the one hand, to the limited number of openings per unit of area. In order to achieve larger numbers of openings or nozzles, the spinning nozzle arrangement can theoretically be enlarged without limit, yet numerous commonly known problems arise, particularly if the width is strongly increased in relation to the length. The most frequent problem is a shortening of the working life of the spinning nozzle arrangement. The base plate provided with the nozzles or openings is usually rectangular in top view, the four side edges being welded directly onto the opposing side walls and end walls of the rectangular body. If the width of the base plate increases, then the base plate acts as a beam which is supported at the sides and ends with no support in the middle. Considerable bending stresses, which, due to the lengthy contact with the heavy molten material, in time affect the base plate, lead to sagging as a result of a time-dependent plastic deformation or a time-dependent creep. This sagging, because it leads to an uneven heat distribution, is detrimental to the simultaneous production of fibres of different diameters across the base plate. A diminution of the surface area would therefore be necessary in order to limit the consequences of the creep and thus increase the working life, which leads, however, to an unwanted reduction in output.

These problems have been addressed in DE 19638056, EP 1399393 and EP 1193225, wherein metal plates have been welded to the base plate, as stiffening elements inside the spinning nozzle arrangement, so as thus to produce an increased rigidity of the base plate. In U.S. Pat. No. 594,813, it is instead shown that this effect can also be produced by a bead in the base plate.

These approaches are all less than fully satisfactory, however, since in this way, on the one hand, the desired advantageous effect is limited, whilst, on the other hand, a part of the surface area of the base plate is no longer available for the introduction of openings or nozzles, which produces, in turn, a reduction in output. This could be offset with a further enlargement, but the sagging problem is hereby further intensified, so that further reinforcing measures are necessary which in the end render the productivity growth associated with an enlargement ultimately unattractive.

A further problem lies in the fact that, as a result of the influx of the liquid glass melt into the spinning nozzle arrangement, a hydrodynamic pressure is built up, which acts also upon the other sides of the spinning nozzle arrangement, such as the side walls, end plates and, above all, the cover plates, which, in the event of an enlargement of the base plate, have an increasingly large surface area. Although these, built into a glass fibre production plant, are supported from the outside, stresses are nevertheless generated in the spinning nozzle arrangement, which further shorten the working life.

The object of the invention was to provide a spinning nozzle arrangement, which enables an increase, and thus an improvement, in productivity without the said drawbacks and displays as homogeneous a temperature distribution as possible in the region of the nozzle.

The object is achieved by a spinning nozzle arrangement (10) for the manufacture of glass fibres, having a melting chamber (11) which is formed by side walls (12, 12′), cover plates (14, 14′), end plates, a base plate (1), which is provided with a multiplicity of openings or nozzles (2) aligned parallel to the side walls (12) of the spinning nozzle (10), and a feed line (13) for the glass melt (17), characterized in that the base plate (1) is provided on its top side with additional stiffening elements (4), which are connected to the cover plates (14, 14′).

The core of the invention is to make use of the hydrodynamic pressure and to divert the generated forces to the base plate situated opposite the cover plates in order there, once again, to reduce the sagging and thus increase the working life of the spinning nozzle arrangement.

In one embodiment of the invention, the stiffening elements are of rod-shaped configuration.

These can be at right angles or inclined in relation to the base plate, depending on the design of the spinning nozzle arrangement.

Advantageously, the stiffening elements have a thickness of 1 mm to 3 mm.

In order better to distribute the forces into the cover plate and/or the base plate, the stiffening elements are fitted by means of reinforcing elements. These can be, for example, reinforcing discs having advantageously 1.5 to 10 times the thickness of the stiffening element, i.e., for example, in the case of rods as stiffening elements, discs of corresponding diameter. The openings or nozzles (2) are advantageously combined into two or more, preferably 3 to 5 rows, in main rows.

Power connections (6) are advantageously, and as often customary, connected via end plates (5) and (5′).

The stiffening elements (4) can also be configured as profiles or metal plates or metal plate portions which possess I- V-, U-, T- or double-T-shaped profiles and, given appropriate size, where necessary, have apertures for the passage of the glass melt, in similar fashion as described, inter alia, in DE 19638056, in order, on the one hand, not to obstruct the flux, at the same time as these can then also act to monitor the glass flow. The bores in the stiffening elements have diameters of preferably 5 to 15 mm.

The invention further relates to the use of a spinning nozzle arrangement according to the invention for the manufacture of glass fibres, and to an apparatus for the manufacture of glass fibres, containing a spinning nozzle arrangement according to the invention.

The invention further relates to a method for the manufacture of glass fibres, wherein the starting materials for the glass are fused, the formed glass melt is fed to a spinning nozzle arrangement, in which the glass mass is discharged through openings, and the glass threads discharged from the nozzles are drawn off, cooled and bunched together to form one or more fibre bundles, characterized in that a spinning nozzle arrangement according to the invention is used.

The main rows of the tips of the spinning nozzle arrangement are here generally aligned parallel to the side walls of the spinning nozzle arrangement.

The stiffening elements are preferably produced from the same material as the other constituent parts of the spinning nozzle arrangement, usually a platinum/rhodium alloy or platinum/iridium alloy having a rhodium or iridium component of 10 to 35% by weight, or platinum, rhodium or iridium itself, these metals being used particularly advantageously, as oxide-dispersed, fine-grain-stabilized materials.

If metal plates or profiles, in particular V-profiles, are used, then these, as far as possible, are also connected (for example welded) to the end plates. The installation of the stiffening elements produces a rapid and more homogeneous temperature distribution on the base plate, whereby a homogeneous, even thread draw-off is possible. As a result of the improved temperature distribution, the standard deviation of the fibre diameter improves by up to 20%. The stiffening of the base plate additionally brings about an improvement in the long-term stability of the base plate, so that the working life of the spinning nozzle arrangement is significantly increased.

In a further preferred variant of the apparatus according to the invention, beneath the base plate, between the main rows of the tips, special cooling elements, such as, for example, cooling tubes or cooling fins, are fitted, which, where necessary, have additional cooling fins on their top side and/or bottom side for improving the heat exchange.

The tips of the nozzle plate are cylindrical or conical, depending on the manufacturing method, and have, in particular, a bore diameter of 1 to 2.5 mm. The smallest distance between the tips within the tip main rows is, in particular, >/=2.5 mm, preferably from 2.5 to 6 mm.

The thickness of the power connections is preferably from 2.5 to 7 mm and is chosen in dependence on the width.

The draw-off rate of the glass fibres is often about 600 to 3000 m/min, preferably from 600 to 1500 m/min.

The stiffening elements preferably have a thickness of 0.5 to 3 mm, in particular of 0.5 to 1.6 mm.

The contact faces of the power connections generally have a width of 20 to 100 mm and enclose between them a clearance of, in general, 15 to 30 mm. The spinning nozzles according to the invention are used for the manufacture of glass fibres having a diameter of, in particular, 8 to 30 μm, preferably of 9 to 24 μm.

Further preferable embodiments of the invention can be derived from the dependent patent claims.

The invention is explained in greater detail below on an illustrative basis with reference to the figures. In the figures:

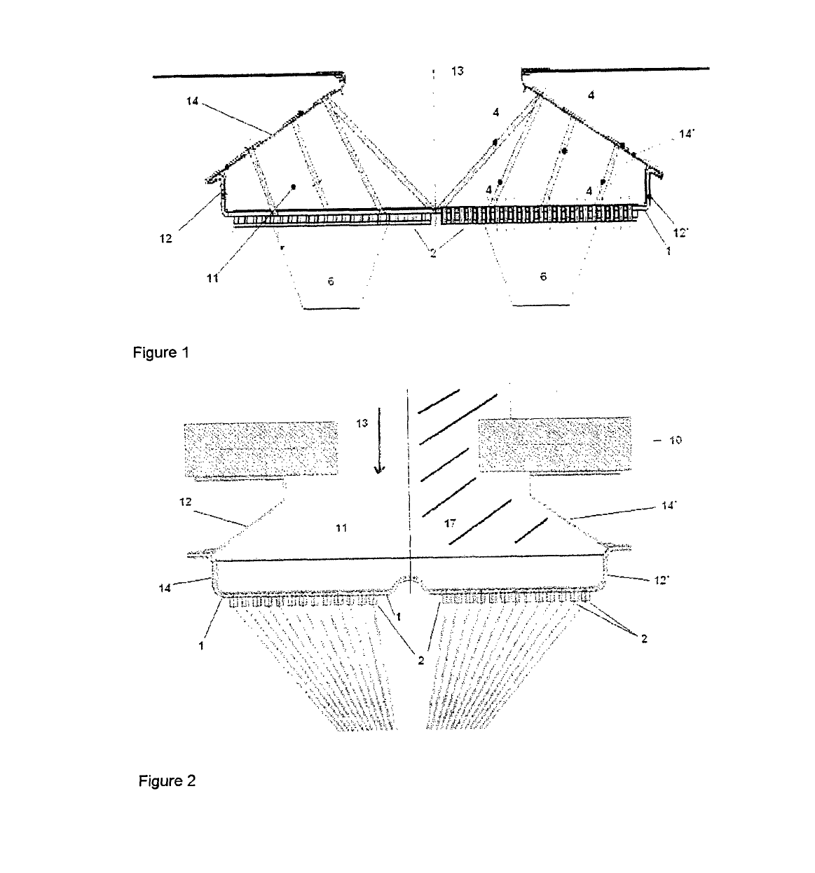

FIG. 1 shows a cross section through the inner part of a spinning nozzle arrangement according to the invention with stiffening elements.

FIG. 2 shows the cross section through a known spinning nozzle arrangement having a bead as the stiffening element. The surface area loss is hereby evident.

1-11. (canceled)

12. A spinning nozzle arrangement for the manufacture of glass fibres, comprising:
a melting chamber comprising a plurality of side walls, a plurality of cover plates, a plurality of end plates, and a base plate, wherein the base plate includes a multiplicity of openings, and wherein the openings are aligned parallel to the side walls of the melting chamber, and
a feed line,
wherein the base plate includes a plurality of stiffening elements on its top side, and wherein the plurality of stiffening elements are connected to the plurality of cover plates.

13. The arrangement of claim 12, wherein the stiffening elements are of rod-shaped configuration.

14. The arrangement of claim 12, wherein the stiffening elements are inclined in relation to the base plate.

15. The arrangement of claim 12, wherein the stiffening elements have a thickness of 1 mm to 3 mm.

16. The arrangement of claim 12, wherein the stiffening elements are fitted into the cover plate, the base plate or both by means of reinforcing elements.

17. The arrangement of claim 12, wherein the openings are arranged into two or more rows aligned close together in main rows.

18. The arrangement of claim 12, wherein power connections are connected via the end plates.

19. The arrangement of claim 12, wherein the stiffening elements are configured to have I-, V-, U-, T- or double-T-shaped profiles.

20. The arrangement of claim 19, wherein the stiffening elements have apertures for the passage of the glass melt.

21. An apparatus for the manufacture of glass fibres, containing the spinning nozzle arrangement of claim 12.

22. A method for the manufacture of glass fibres, comprising
fusing starting materials for glass to form a glass melt,
feeding the glass melt to the spinning nozzle arrangement of claim 12,
discharging glass fibres through openings in the nozzle arrangement, and
drawing off, cooling, and bunching together the glass fibres discharged from the openings.
